(19) United States
(12) Patent Application Publication
(10) Pub. No.: US 2024/0295880 A1
(43) Pub. Date: Sep. 5, 2024

(54) Robot Collaboration via Cloud Server

(71) Applicant: Google LLC, Mountain View, CA (US)

(72) Inventors: Rainer Hessmer, Los Gatos, CA (US); Nikhil J. Joshi, Fremont, CA (US); Daniel Lam, Mountain View, CA (US); Pavel Vodenski, San Carlos, CA (US)

(21) Appl. No.: 18/176,937

(22) Filed: Mar. 1, 2023

(51) Int. Cl. G05D 1/02

(52) U.S. Cl. CPC G05D 1/0295

(57) ABSTRACT

A method includes receiving, by a robotic device, an indication that the robotic device was elected to be a leader robotic device by a plurality of robotic devices and receiving an indication of a new task in a remotely stored list of tasks. The method further includes determining, based on a remotely stored list of robotic devices, an additional robotic device to assign the new task. The remotely stored list of robotic devices comprises an entry for each respective robotic device of the plurality of robotic devices associating the respective robotic device with an identifier and a heartbeat. The method additionally includes assigning the new task to the additional robotic device based on the additional robotic device having an active heartbeat. Assigning the new task to the additional robotic device comprises associating the new task with the additional robotic device in the remotely stored list of tasks to cause the additional robotic device to carry out the new task.

### BACKGROUND

As technology advances, various types of robotic devices are being created for performing a variety of functions that may assist users. Robotic devices may be used for applications involving material handling, transportation, welding, assembly, and dispensing, among others. Over time, the manner in which these robotic systems operate is becoming more intelligent, efficient, and intuitive. As robotic systems become increasingly prevalent in numerous aspects of modern life, it is desirable for robotic systems to be efficient. Therefore, a demand for efficient robotic systems has helped open up a field of innovation in actuators, movement, sensing techniques, as well as component design and assembly.

### SUMMARY

Example embodiments involve a system for robot collaboration for a fleet of robotic devices operating in an environment. Each robot in the fleet may be associated with an entry in a remotely stored list of robotic devices, where each entry includes an identifier and a heartbeat indicating whether the robotic device is active. Further, robotic devices in the remotely stored list of robotic devices may be assigned to a task from a remotely stored list of tasks. A leader robotic device may communicate with a database storing the remotely stored list of robotic devices and the remotely stored list of tasks to distribute tasks to robotic devices with an active heartbeat.

In an embodiment, a method includes receiving, by a robotic device, an indication that the robotic device was elected to be a leader robotic device by a plurality of robotic devices. The method also includes receiving, by the leader robotic device, an indication of a new task in a remotely stored list of tasks. The method further includes determining, by the leader robotic device and based on a remotely stored list of robotic devices, an additional robotic device to assign the new task. The remotely stored list of robotic devices comprises an entry for each respective robotic device of the plurality of robotic devices associating the respective robotic device with an identifier and a heartbeat. The method additionally includes assigning, by the leader robotic device, the new task to the additional robotic device based on the additional robotic device having an active heartbeat. Assigning the new task to the additional robotic device comprises associating the new task with the additional robotic device in the remotely stored list of tasks to cause the additional robotic device to carry out the new task.

In an embodiment, a robotic device includes a control system configured to receive, by the robotic device, an indication that the robotic device was elected to be a leader robotic device by a plurality of robotic devices. The control system is further configured to receive, by the leader robotic device, an indication of a new task in a remotely stored list of tasks. The control system is also configured to determine, by the leader robotic device and based on a remotely stored list of robotic devices, an additional robotic device to assign the new task. The remotely stored list of robotic devices comprises an entry for each respective robotic device of the plurality of robotic devices associating the respective robotic device with an identifier and a heartbeat. The control system is also configured to assign, by the leader robotic device, the new task to the additional robotic device based on the additional robotic device having an active heartbeat. Assigning the new task to the additional robotic device comprises associating the new task with the additional robotic device in the remotely stored list of tasks to cause the additional robotic device to carry out the new task.

In an embodiment, a non-transitory computer readable medium comprising program instructions executable by at least one processor to cause the at least one processor to perform functions. The functions include receiving, by a robotic device, an indication that the robotic device was elected to be a leader robotic device by a plurality of robotic devices. The functions also include receiving, by the leader robotic device, an indication of a new task in a remotely stored list of tasks. The functions further include determining, by the leader robotic device and based on a remotely stored list of robotic devices, an additional robotic device to assign the new task. The remotely stored list of robotic devices comprises an entry for each respective robotic device of the plurality of robotic devices associating the respective robotic device with an identifier and a heartbeat. The functions additionally include assigning, by the leader robotic device, the new task to the additional robotic device based on the additional robotic device having an active heartbeat. Assigning the new task to the additional robotic device comprises associating the new task with the additional robotic device in the remotely stored list of tasks to cause the additional robotic device to carry out the new task.

In another embodiment, a system is provided that provides means for receiving, by a robotic device, an indication that the robotic device was elected to be a leader robotic device by a plurality of robotic devices. The system also includes means for receiving, by the leader robotic device, an indication of a new task in a remotely stored list of tasks. The system further includes means for determining, by the leader robotic device and based on a remotely stored list of robotic devices, an additional robotic device to assign the new task. The remotely stored list of robotic devices comprises an entry for each respective robotic device of the plurality of robotic devices associating the respective robotic device with an identifier and a heartbeat. The system additionally includes means for assigning, by the leader robotic device, the new task to the additional robotic device based on the additional robotic device having an active heartbeat. Assigning the new task to the additional robotic device comprises associating the new task with the additional robotic device in the remotely stored list of tasks to cause the additional robotic device to carry out the new task.

In a further embodiment, a system for distributing and synchronizing tasks among a plurality of robotic devices is provided. The system comprises a database server having stored thereon a list of tasks and a list of robotic devices, where the list of robotic devices comprises an entry for each respective robotic device of the plurality of robotic devices, where each entry associates the respective robotic device with an identifier and a heartbeat. The system also comprises the plurality of robotic devices, where a given robotic device of the plurality of robotic devices comprises a control system. The control system is configured to receive, by the given robotic device from the database server, a first wireless communication signal indicating that the given robotic device was elected to be a leader robotic device by the plurality of robotic devices, where the system is configured to replace the leader robotic device if the leader robotic device has an inactive heartbeat. The control system is also configured to receive, by the leader robotic device from the database server, a second wireless communication signal indicating a new task in the list of tasks stored at the database server. The control system is further configured to determine, by the leader robotic device and based on the list of robotic devices stored at the database server, an additional robotic device to assign the new task. The control system is additionally configured to assign, by the leader robotic device, the new task to the additional robotic device based on the additional robotic device having an active heartbeat, where the additional robotic device is configured to perform the new task responsive to receiving, from the database server, a third wireless communication signal indicating that the new task is assigned to the additional robotic device in the list of tasks stored at the database server.

In an additional embodiment, a method for distributing and synchronizing tasks among a plurality of robotic devices is provided. The method includes receiving, by the given robotic device from the database server, a first wireless communication signal indicating that the given robotic device was elected to be a leader robotic device by the plurality of robotic devices, where a system is configured to replace the leader robotic device if the leader robotic device has an inactive heartbeat. The system comprises a database server having stored thereon a list of tasks and a list of robotic devices, where the list of robotic devices comprises an entry for each respective robotic device of the plurality of robotic devices, where each entry associates the respective robotic device with an identifier and a heartbeat. The system also comprises the plurality of robotic devices, where a given robotic device of the plurality of robotic devices comprises a control system. The method also includes receiving, by the leader robotic device from the database server, a second wireless communication signal indicating a new task in the list of tasks stored at the database server. The method further includes determining, by the leader robotic device and based on the list of robotic devices stored at the database server, an additional robotic device to assign the new task. The method additionally includes, by the leader robotic device, the new task to the additional robotic device based on the additional robotic device having an active heartbeat, where the additional robotic device is configured to perform the new task responsive to receiving, from the database server, a third wireless communication signal indicating that the new task is assigned to the additional robotic device in the list of tasks stored at the database server.

In another embodiment, a non-transitory computer readable medium for distributing and synchronizing tasks among a plurality of robotic devices is provided. The non-transitory computer readable medium comprises program instructions executable by at least one processor to cause the at least one processor to perform functions. The functions include receiving, by the given robotic device from the database server, a first wireless communication signal indicating that the given robotic device was elected to be a leader robotic device by the plurality of robotic devices, where a system is configured to replace the leader robotic device if the leader robotic device has an inactive heartbeat. The system comprises a database server having stored thereon a list of tasks and a list of robotic devices, where the list of robotic devices comprises an entry for each respective robotic device of the plurality of robotic devices, where each entry associates the respective robotic device with an identifier and a heartbeat. The system also comprises the plurality of robotic devices, where a given robotic device of the plurality of robotic devices comprises a control system. The functions also include receiving, by the leader robotic device from the database server, a second wireless communication signal indicating a new task in the list of tasks stored at the database server. The functions further include determining, by the leader robotic device and based on the list of robotic devices stored at the database server, an additional robotic device to assign the new task. The functions additionally include, by the leader robotic device, the new task to the additional robotic device based on the additional robotic device having an active heartbeat, where the additional robotic device is configured to perform the new task responsive to receiving, from the database server, a third wireless communication signal indicating that the new task is assigned to the additional robotic device in the list of tasks stored at the database server.

In a further embodiment, a system that includes means for distributing and synchronizing tasks among a plurality of robotic devices is provided. The system includes means for include receiving, by the given robotic device from the database server, a first wireless communication signal indicating that the given robotic device was elected to be a leader robotic device by the plurality of robotic devices, where a system is configured to replace the leader robotic device if the leader robotic device has an inactive heartbeat. The system comprises a database server having stored thereon a list of tasks and a list of robotic devices, where the list of robotic devices comprises an entry for each respective robotic device of the plurality of robotic devices, where each entry associates the respective robotic device with an identifier and a heartbeat. The system also comprises the plurality of robotic devices, where a given robotic device of the plurality of robotic devices comprises a control system. The system also includes means for receiving, by the leader robotic device from the database server, a second wireless communication signal indicating a new task in the list of tasks stored at the database server. The system also includes means for determining, by the leader robotic device and based on the list of robotic devices stored at the database server, an additional robotic device to assign the new task. The system also includes means for including, by the leader robotic device, the new task to the additional robotic device based on the additional robotic device having an active heartbeat, where the additional robotic device is configured to perform the new task responsive to receiving, from the database server, a third wireless communication signal indicating that the new task is assigned to the additional robotic device in the list of tasks stored at the database server.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates a configuration of a robotic system, in accordance with example embodiments.

FIG. 2 illustrates a mobile robot, in accordance with example embodiments.

FIG. 3 illustrates an exploded view of a mobile robot, in accordance with example embodiments.

FIG. 4 illustrates a robotic arm, in accordance with example embodiments.

FIG. 5 is a block diagram of a method, in accordance with example embodiments.

FIG. 6 depicts an environment, in accordance with example embodiments.

FIG. 7 depicts a communication workflow, in accordance with example embodiments.

FIG. 8 depicts a remotely stored list of robotic devices and an updated remotely stored list of robotic devices, in accordance with example embodiments.

FIG. 9 depicts a remotely stored list of leader robotic devices and an updated remotely stored list of robotic devices, in accordance with example embodiments.

FIG. 10 depicts a remotely stored list of tasks and an updated remotely stored list of tasks, in accordance with example embodiments.

FIG. 11 depicts an environment, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms.

The use of ordinal numbers such as “first,” “second,” “third” and so on is to distinguish respective elements rather than to denote a particular order of those elements. For purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. OVERVIEW

A fleet of robotic devices may carry out various tasks in an environment. For example, in an office environment, a robotic device of the fleet of robotic devices may be tasked with picking up and delivering packages around the office. Another robotic device of the fleet of robotic devices may be tasked with wiping tables, and yet another robotic device may be tasked with sweeping the floors. These tasks may be scripted such that the same robotic device carries out the task.

An issue may arise when a robotic device in carrying out its assigned task comes across a task that it cannot carry out and that prevents it from completing its assigned task. For example, a robotic device that is tasked with sweeping floors may have a vacuum feature, but may not be able to pick up objects. In sweeping floors, the robotic device may come across a package. Consequently, the robotic device may be unable to finish sweeping the floor. As another example, a robotic device that is tasked with wiping tables may be equipped with a wiping mechanism but may be unable to clear tables. In wiping a table, the robotic device may detect multiple objects on a table that need to be cleared before it can wipe the table.

Provided herein are systems for a free-form robot collaboration system that may allow a fleet of robotic devices to autonomously collaborate on tasks, perhaps without the use of a central coordinating script or execution engine. In particular, each robotic device in the fleet of robotic devices may communicate with a server, which may transmit assigned tasks to each robotic device. The server may store a remotely stored list of robotic devices and a remotely stored list of tasks. In some examples, a server may store the remotely stored list of robotic devices and another server may store the remotely stored list of tasks.

The remotely stored list of robotic devices may include entries for each robotic device in the fleet of robotic devices. Each entry in the remotely stored list of robotic devices may include an identifier and a heartbeat. A new robotic device in the fleet of robotic devices may transmit an indication to a server storing the list of robotic devices to add it to the remotely stored list of robotic devices. In response to receiving this request, the server may create an entry in the list of robotic devices. The new robotic device may then periodically transmit an indication to the server that it is still active, which may cause the server to maintain the associated heartbeat entry to indicate that the robotic device is still alive. In some examples, the associated heartbeat entry may indicate the last time the robotic device checked in or the time since the robotic device last checked in.

The remotely stored list of tasks may include entries for each task and which robotic device is assigned to the task. In some examples, a robotic device carrying out an assigned task may detect an additional task to be completed. The robotic device may send an indication of the additional task to a server storing the remotely stored list of tasks, and in response, the server may add the additional task to the remotely stored list of tasks. Additionally and/or alternatively, operators monitoring the fleet of robotic devices and/or robotic devices operating in the environment may send various tasks to the server device to add to the remotely stored list of tasks, which may cause the task to be assigned to a robotic device and cause the robotic device to carry out the task.

In some examples, a new robotic device or a robotic device that has finished completing its task may monitor the remotely stored list of tasks for a task that it can complete. Upon finding such a task, the robotic device may transmit an indication to the server that stores the remotely stored list of tasks to update the list of tasks to indicate that the robotic device is assigned to the task.

Additionally and/or alternatively, the fleet of robotic devices may elect a leader robotic device, perhaps through a leadership election algorithm, and the leader robotic device may monitor the remotely stored list of robotic devices and/or the remotely stored list of tasks. When a task is added to the remotely stored list of tasks, the leader robotic device may determine a robotic device from the remotely stored list of robotic devices that is capable of carrying out the new task, and the leader robotic device may assign the task to that robotic device. Additionally and/or alternatively, when a new robotic device is added to the remotely stored list of robotic devices, the leader robotic device may determine a task from the remotely stored list of tasks to assign the new robotic device.

The leader robotic device may monitor the remotely stored list of tasks and/or the remotely stored list of robotic devices to facilitate the completion of tasks. For example, the leader robotic device may monitor the heartbeats of the robotic devices to determine whether each robotic device assigned to a task is still active. If a robotic device assigned to a particular task is no longer active, the leader robotic device may determine another robotic device from the remotely stored list of robotic devices to assign the task. The leader robotic device may update the list of tasks to associate the task with the other robotic device and cause the server storing the list of tasks to send an indication to the other robotic device to carry out the task.

Having a robot collaboration system where the robotic devices communicate with a server rather than a robot collaboration system where robotic devices that communicate with each other enables a scalable system. For example, in a system where the robotic devices communicate with each other, if a robotic device in the fleet of robotic devices is no longer able to communicate with other robotic devices, each robotic device in the fleet may separately determine that the robotic device is no longer active and which robotic device should be assigned the new task. Such a system may increase exponentially in complexity as the number of robotic devices in the fleet of robotic devices increases. In contrast, for a system where each robotic device in the fleet of robotic devices communicate with a server, the increase in complexity may be negligible in comparison as each additional robotic device only needs to receive signals from and transmit signals to a server storing the list of robotic devices, and perhaps a server storing the list of tasks.

In particular, having a leader robotic device may enable more efficient robot collaboration among robotic devices in the fleet of robotic devices and more efficient task assignment. For example, without a leader robotic device, each robotic device in the fleet of robotic devices may have to to separately communicate with the server. Each robotic device may receive an indication of a new task, and each robotic device may then determine whether it can perform the task. For a fleet with many robotic devices, this process may cause some unnecessary redundancies as several robotic devices may reach the conclusion that it could carry out the task, when only one robotic device is needed to carry out the task. Further, each robotic device may separately monitor the list of robotic devices to ensure no robotic device carrying out a task has become inactive, which may cause similar redundancies. The server may take the place of the leader robotic device in monitoring the list of robotic devices and the list of tasks. However, having a leader robotic device may ensure that at least one device is monitoring the list of robotic devices and list of tasks, since a new leader robotic device can be elected when the previous leader robotic device goes offline.

In addition, having a leader robotic device and promptly replacing the leader robotic device may facilitate fault prevention. In particular, with the leader robotic device being the only robotic device assigning tasks, the system may avoid multiple robotic devices assigning themselves to a task, no robotic devices assigning themselves to a task, robotic devices assigning themselves to a task but being unable to actually perform the task, and communication failures that may occur with sending signals to each robotic device when a new task is being added, among other failures. Further, electing a leader robotic device if the leader robotic device has an an inactive heartbeat may further avoidance of the issues listed above, as another robotic device may take over the responsibilities of assigning robotic devices to various tasks, rather than allowing tasks to remain unassigned.

### II. EXAMPLE ROBOTIC SYSTEMS

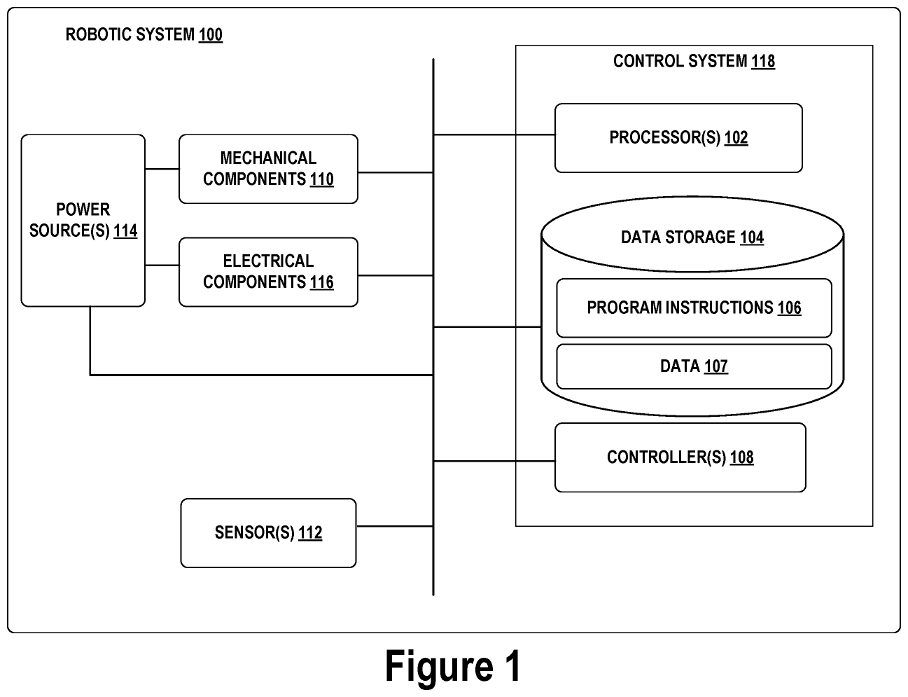

FIG. 1 illustrates an example configuration of a robotic system that may be used in connection with the implementations described herein. Robotic system 100 may be configured to operate autonomously, semi-autonomously, or using directions provided by user(s). Robotic system 100 may be implemented in various forms, such as a robotic arm, industrial robot, or some other arrangement. Some example implementations involve a robotic system 100 engineered to be low cost at scale and designed to support a variety of tasks. Robotic system 100 may be designed to be capable of operating around people. Robotic system 100 may also be optimized for machine learning. Throughout this description, robotic system 100 may also be referred to as a robot, robotic device, or mobile robot, among other designations.

As shown in FIG. 1, robotic system 100 may include processor(s) 102, data storage 104, and controller(s) 108, which together may be part of control system 118. Robotic system 100 may also include sensor(s) 112, power source(s) 114, mechanical components 110, and electrical components 116. Nonetheless, robotic system 100 is shown for illustrative purposes, and may include more or fewer components. The various components of robotic system 100 may be connected in any manner, including wired or wireless connections. Further, in some examples, components of robotic system 100 may be distributed among multiple physical entities rather than a single physical entity. Other example illustrations of robotic system 100 may exist as well.

Processor(s) 102 may operate as one or more general-purpose hardware processors or special purpose hardware processors (e.g., digital signal processors, application specific integrated circuits, etc.). Processor(s) 102 may be configured to execute computer-readable program instructions 106, and manipulate data 107, both of which are stored in data storage 104. Processor(s) 102 may also directly or indirectly interact with other components of robotic system 100, such as sensor(s) 112, power source(s) 114, mechanical components 110, or electrical components 116.

Data storage 104 may be one or more types of hardware memory. For example, data storage 104 may include or take the form of one or more computer-readable storage media that can be read or accessed by processor(s) 102. The one or more computer-readable storage media can include volatile or non-volatile storage components, such as optical, magnetic, organic, or another type of memory or storage, which can be integrated in whole or in part with processor(s) 102. In some implementations, data storage 104 can be a single physical device. In other implementations, data storage 104 can be implemented using two or more physical devices, which may communicate with one another via wired or wireless communication. As noted previously, data storage 104 may include the computer-readable program instructions 106 and data 107. Data 107 may be any type of data, such as configuration data, sensor data, or diagnostic data, among other possibilities.

Controller 108 may include one or more electrical circuits, units of digital logic, computer chips, or microprocessors that are configured to (perhaps among other tasks), interface between any combination of mechanical components 110, sensor(s) 112, power source(s) 114, electrical components 116, control system 118, or a user of robotic system 100. In some implementations, controller 108 may be a purpose-built embedded device for performing specific operations with one or more subsystems of the robotic system 100.

Control system 118 may monitor and physically change the operating conditions of robotic system 100. In doing so, control system 118 may serve as a link between portions of robotic system 100, such as between mechanical components 110 or electrical components 116. In some instances, control system 118 may serve as an interface between robotic system 100 and another computing device. Further, control system 118 may serve as an interface between robotic system 100 and a user. In some instances, control system 118 may include various components for communicating with robotic system 100, including a joystick, buttons, or ports, etc. The example interfaces and communications noted above may be implemented via a wired or wireless connection, or both. Control system 118 may perform other operations for robotic system 100 as well.

During operation, control system 118 may communicate with other systems of robotic system 100 via wired or wireless connections, and may further be configured to communicate with one or more users of the robot. As one possible illustration, control system 118 may receive an input (e.g., from a user or from another robot) indicating an instruction to perform a requested task, such as to pick up and move an object from one location to another location. Based on this input, control system 118 may perform operations to cause the robotic system 100 to make a sequence of movements to perform the requested task. As another illustration, a control system may receive an input indicating an instruction to move to a requested location. In response, control system 118 (perhaps with the assistance of other components or systems) may determine a direction and speed to move robotic system 100 through an environment en route to the requested location.

Operations of control system 118 may be carried out by processor(s) 102. Alternatively, these operations may be carried out by controller(s) 108, or a combination of processor(s) 102 and controller(s) 108. In some implementations, control system 118 may partially or wholly reside on a device other than robotic system 100, and therefore may at least in part control robotic system 100 remotely.

Mechanical components 110 represent hardware of robotic system 100 that may enable robotic system 100 to perform physical operations. As a few examples, robotic system 100 may include one or more physical members, such as an arm, an end effector, a head, a neck, a torso, a base, and wheels. The physical members or other parts of robotic system 100 may further include actuators arranged to move the physical members in relation to one another. Robotic system 100 may also include one or more structured bodies for housing control system 118 or other components, and may further include other types of mechanical components. The particular mechanical components 110 used in a given robot may vary based on the design of the robot, and may also be based on the operations or tasks the robot may be configured to perform.

In some examples, mechanical components 110 may include one or more removable components. Robotic system 100 may be configured to add or remove such removable components, which may involve assistance from a user or another robot. For example, robotic system 100 may be configured with removable end effectors or digits that can be replaced or changed as needed or desired. In some implementations, robotic system 100 may include one or more removable or replaceable battery units, control systems, power systems, bumpers, or sensors. Other types of removable components may be included within some implementations.

Robotic system 100 may include sensor(s) 112 arranged to sense aspects of robotic system 100. Sensor(s) 112 may include one or more force sensors, torque sensors, velocity sensors, acceleration sensors, position sensors, proximity sensors, motion sensors, location sensors, load sensors, temperature sensors, touch sensors, depth sensors, ultrasonic range sensors, infrared sensors, object sensors, or cameras, among other possibilities. Within some examples, robotic system 100 may be configured to receive sensor data from sensors that are physically separated from the robot (e.g., sensors that are positioned on other robots or located within the environment in which the robot is operating).

Sensor(s) 112 may provide sensor data to processor(s) 102 (perhaps by way of data 107) to allow for interaction of robotic system 100 with its environment, as well as monitoring of the operation of robotic system 100. The sensor data may be used in evaluation of various factors for activation, movement, and deactivation of mechanical components 110 and electrical components 116 by control system 118. For example, sensor(s) 112 may capture data corresponding to the terrain of the environment or location of nearby objects, which may assist with environment recognition and navigation.

In some examples, sensor(s) 112 may include RADAR (e.g., for long-range object detection, distance determination, or speed determination), LIDAR (e.g., for short-range object detection, distance determination, or speed determination), SONAR (e.g., for underwater object detection, distance determination, or speed determination), VICON® (e.g., for motion capture), one or more cameras (e.g., stereoscopic cameras for 3D vision), a global positioning system (GPS) transceiver, or other sensors for capturing information of the environment in which robotic system 100 is operating. Sensor(s) 112 may monitor the environment in real time, and detect obstacles, elements of the terrain, weather conditions, temperature, or other aspects of the environment. In another example, sensor(s) 112 may capture data corresponding to one or more characteristics of a target or identified object, such as a size, shape, profile, structure, or orientation of the object.

Further, robotic system 100 may include sensor(s) 112 configured to receive information indicative of the state of robotic system 100, including sensor(s) 112 that may monitor the state of the various components of robotic system 100. Sensor(s) 112 may measure activity of systems of robotic system 100 and receive information based on the operation of the various features of robotic system 100, such as the operation of an extendable arm, an end effector, or other mechanical or electrical features of robotic system 100. The data provided by sensor(s) 112 may enable control system 118 to determine errors in operation as well as monitor overall operation of components of robotic system 100.

As an example, robotic system 100 may use force/torque sensors to measure load on various components of robotic system 100. In some implementations, robotic system 100 may include one or more force/torque sensors on an arm or end effector to measure the load on the actuators that move one or more members of the arm or end effector. In some examples, the robotic system 100 may include a force/torque sensor at or near the wrist or end effector, but not at or near other joints of a robotic arm. In further examples, robotic system 100 may use one or more position sensors to sense the position of the actuators of the robotic system. For instance, such position sensors may sense states of extension, retraction, positioning, or rotation of the actuators on an arm or end effector.

As another example, sensor(s) 112 may include one or more velocity or acceleration sensors. For instance, sensor(s) 112 may include an inertial measurement unit (IMU). The IMU may sense velocity and acceleration in the world frame, with respect to the gravity vector. The velocity and acceleration sensed by the IMU may then be translated to that of robotic system 100 based on the location of the IMU in robotic system 100 and the kinematics of robotic system 100.

Robotic system 100 may include other types of sensors not explicitly discussed herein. Additionally or alternatively, the robotic system may use particular sensors for purposes not enumerated herein.

Robotic system 100 may also include one or more power source(s) 114 configured to supply power to various components of robotic system 100. Among other possible power systems, robotic system 100 may include a hydraulic system, electrical system, batteries, or other types of power systems. As an example illustration, robotic system 100 may include one or more batteries configured to provide charge to components of robotic system 100. Some of mechanical components 110 or electrical components 116 may each connect to a different power source, may be powered by the same power source, or be powered by multiple power sources.

Any type of power source may be used to power robotic system 100, such as electrical power or a gasoline engine. Additionally or alternatively, robotic system 100 may include a hydraulic system configured to provide power to mechanical components 110 using fluid power. Components of robotic system 100 may operate based on hydraulic fluid being transmitted throughout the hydraulic system to various hydraulic motors and hydraulic cylinders, for example. The hydraulic system may transfer hydraulic power by way of pressurized hydraulic fluid through tubes, flexible hoses, or other links between components of robotic system 100. Power source(s) 114 may charge using various types of charging, such as wired connections to an outside power source, wireless charging, combustion, or other examples.

Electrical components 116 may include various mechanisms capable of processing, transferring, or providing electrical charge or electric signals. Among possible examples, electrical components 116 may include electrical wires, circuitry, or wireless communication transmitters and receivers to enable operations of robotic system 100. Electrical components 116 may interwork with mechanical components 110 to enable robotic system 100 to perform various operations. Electrical components 116 may be configured to provide power from power source(s) 114 to the various mechanical components 110, for example. Further, robotic system 100 may include electric motors. Other examples of electrical components 116 may exist as well.

Robotic system 100 may include a body, which may connect to or house appendages and components of the robotic system. As such, the structure of the body may vary within examples and may further depend on particular operations that a given robot may have been designed to perform. For example, a robot developed to carry heavy loads may have a wide body that enables placement of the load. Similarly, a robot designed to operate in tight spaces may have a relatively tall, narrow body. Further, the body or the other components may be developed using various types of materials, such as metals or plastics. Within other examples, a robot may have a body with a different structure or made of various types of materials.

The body or the other components may include or carry sensor(s) 112. These sensors may be positioned in various locations on the robotic system 100, such as on a body, a head, a neck, a base, a torso, an arm, or an end effector, among other examples.

Robotic system 100 may be configured to carry a load, such as a type of cargo that is to be transported. In some examples, the load may be placed by the robotic system 100 into a bin or other container attached to the robotic system 100. The load may also represent external batteries or other types of power sources (e.g., solar panels) that the robotic system 100 may utilize. Carrying the load represents one example use for which the robotic system 100 may be configured, but the robotic system 100 may be configured to perform other operations as well.

As noted above, robotic system 100 may include various types of appendages, wheels, end effectors, gripping devices and so on. In some examples, robotic system 100 may include a mobile base with wheels, treads, or some other form of locomotion. Additionally, robotic system 100 may include a robotic arm or some other form of robotic manipulator. In the case of a mobile base, the base may be considered as one of mechanical components 110 and may include wheels, powered by one or more of actuators, which allow for mobility of a robotic arm in addition to the rest of the body.

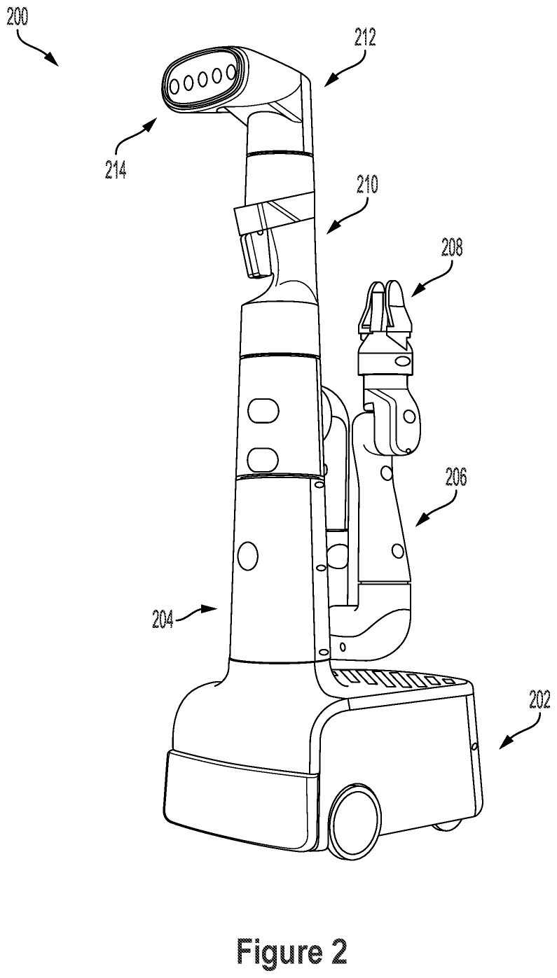

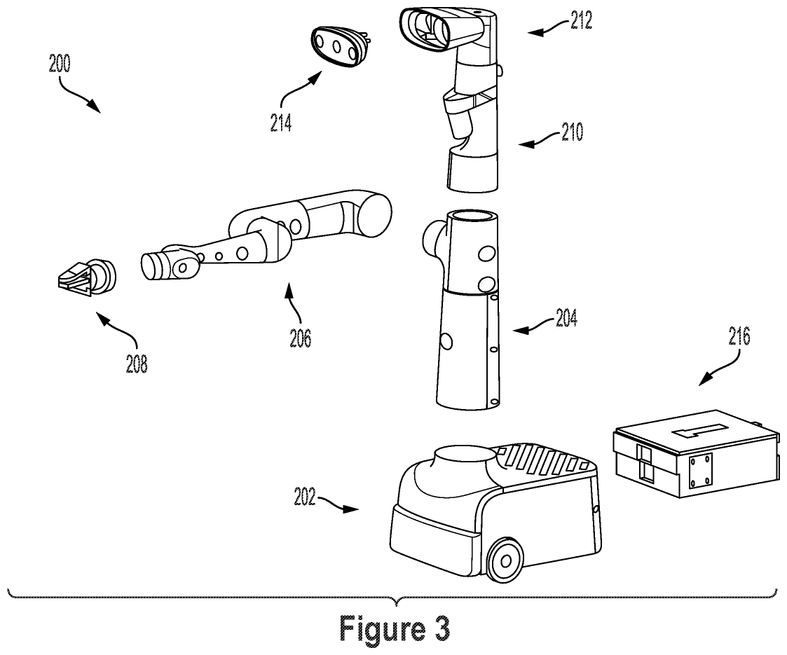

FIG. 2 illustrates a mobile robot, in accordance with example embodiments. FIG. 3 illustrates an exploded view of the mobile robot, in accordance with example embodiments. More specifically, a robot 200 may include a mobile base 202, a midsection 204, an arm 206, an end-of-arm system (EOAS) 208, a mast 210, a perception housing 212, and a perception suite 214. The robot 200 may also include a compute box 216 stored within mobile base 202.

The mobile base 202 includes two drive wheels positioned at a front end of the robot 200 in order to provide locomotion to robot 200. The mobile base 202 also includes additional casters (not shown) to facilitate motion of the mobile base 202 over a ground surface. The mobile base 202 may have a modular architecture that allows compute box 216 to be easily removed. Compute box 216 may serve as a removable control system for robot 200 (rather than a mechanically integrated control system). After removing external shells, the compute box 216 can be easily removed and/or replaced. The mobile base 202 may also be designed to allow for additional modularity. For example, the mobile base 202 may also be designed so that a power system, a battery, and/or external bumpers can all be easily removed and/or replaced.

The midsection 204 may be attached to the mobile base 202 at a front end of the mobile base 202. The midsection 204 includes a mounting column which is fixed to the mobile base 202. The midsection 204 additionally includes a rotational joint for arm 206. More specifically, the midsection 204 includes the first two degrees of freedom for arm 206 (a shoulder yaw J0 joint and a shoulder pitch J1 joint). The mounting column and the shoulder yaw J0 joint may form a portion of a stacked tower at the front of mobile base 202. The mounting column and the shoulder yaw J0 joint may be coaxial. The length of the mounting column of midsection 204 may be chosen to provide the arm 206 with sufficient height to perform manipulation tasks at commonly encountered height levels (e.g., coffee table top and counter top levels). The length of the mounting column of midsection 204 may also allow the shoulder pitch J1 joint to rotate the arm 206 over the mobile base 202 without contacting the mobile base 202.

The arm 206 may be a 7DOF robotic arm when connected to the midsection 204. As noted, the first two DOFs of the arm 206 may be included in the midsection 204. The remaining five DOFs may be included in a standalone section of the arm 206 as illustrated in FIGS. 2 and 3. The arm 206 may be made up of plastic monolithic link structures. Inside the arm 206 may be housed standalone actuator modules, local motor drivers, and thru bore cabling.

The EOAS 208 may be an end effector at the end of arm 206. EOAS 208 may allow the robot 200 to manipulate objects in the environment. As shown in FIGS. 2 and 3, EOAS 208 may be a gripper, such as an underactuated pinch gripper. The gripper may include one or more contact sensors such as force/torque sensors and/or non-contact sensors such as one or more cameras to facilitate object detection and gripper control. EOAS 208 may also be a different type of gripper such as a suction gripper or a different type of tool such as a drill or a brush. EOAS 208 may also be swappable or include swappable components such as gripper digits.

The mast 210 may be a relatively long, narrow component between the shoulder yaw J0 joint for arm 206 and perception housing 212. The mast 210 may be part of the stacked tower at the front of mobile base 202. The mast 210 may be fixed relative to the mobile base 202. The mast 210 may be coaxial with the midsection 204. The length of the mast 210 may facilitate perception by perception suite 214 of objects being manipulated by EOAS 208. The mast 210 may have a length such that when the shoulder pitch J1 joint is rotated vertical up, a topmost point of a bicep of the arm 206 is approximately aligned with a top of the mast 210. The length of the mast 210 may then be sufficient to prevent a collision between the perception housing 212 and the arm 206 when the shoulder pitch J1 joint is rotated vertical up.

As shown in FIGS. 2 and 3, the mast 210 may include a 3D lidar sensor configured to collect depth information about the environment. The 3D lidar sensor may be coupled to a carved-out portion of the mast 210 and fixed at a downward angle. The lidar position may be optimized for localization, navigation, and for front cliff detection.

The perception housing 212 may include at least one sensor making up perception suite 214. The perception housing 212 may be connected to a pan/tilt control to allow for reorienting of the perception housing 212 (e.g., to view objects being manipulated by EOAS 208). The perception housing 212 may be a part of the stacked tower fixed to the mobile base 202. A rear portion of the perception housing 212 may be coaxial with the mast 210.

The perception suite 214 may include a suite of sensors configured to collect sensor data representative of the environment of the robot 200. The perception suite 214 may include an infrared (IR)-assisted stereo depth sensor. The perception suite 214 may additionally include a wide-angled red-green-blue (RGB) camera for human-robot interaction and context information. The perception suite 214 may additionally include a high resolution RGB camera for object classification. A face light ring surrounding the perception suite 214 may also be included for improved human-robot interaction and scene illumination. In some examples, the perception suite 214 may also include a projector configured to project images and/or video into the environment.

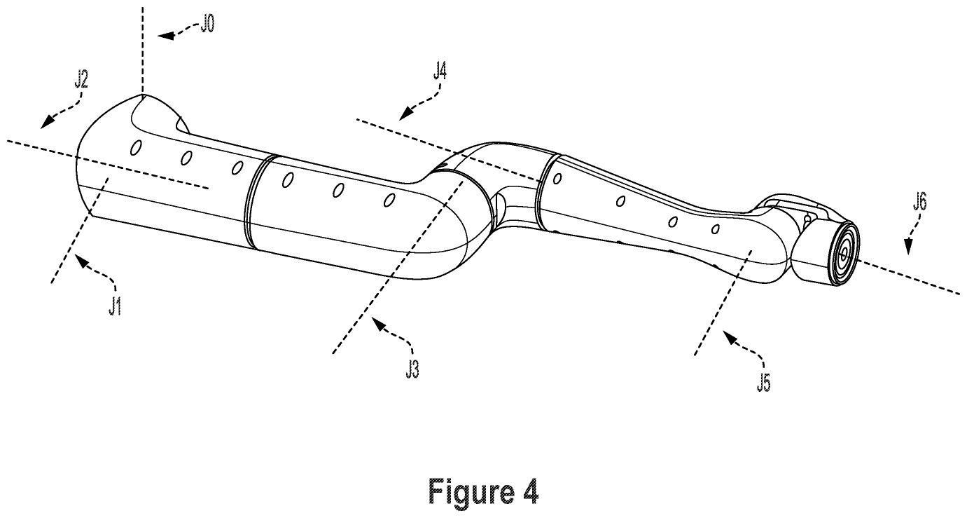

FIG. 4 illustrates a robotic arm, in accordance with example embodiments. The robotic arm includes 7 DOFs: a shoulder yaw J0 joint, a shoulder pitch J1 joint, a bicep roll J2 joint, an elbow pitch J3 joint, a forearm roll J4 joint, a wrist pitch J5 joint, and wrist roll J6 joint. Each of the joints may be coupled to one or more actuators. The actuators coupled to the joints may be operable to cause movement of links down the kinematic chain (as well as any end effector attached to the robot arm).

The shoulder yaw J0 joint allows the robot arm to rotate toward the front and toward the back of the robot. One beneficial use of this motion is to allow the robot to pick up an object in front of the robot and quickly place the object on the rear section of the robot (as well as the reverse motion). Another beneficial use of this motion is to quickly move the robot arm from a stowed configuration behind the robot to an active position in front of the robot (as well as the reverse motion).

The shoulder pitch J1 joint allows the robot to lift the robot arm (e.g., so that the bicep is up to perception suite level on the robot) and to lower the robot arm (e.g., so that the bicep is just above the mobile base). This motion is beneficial to allow the robot to efficiently perform manipulation operations (e.g., top grasps and side grasps) at different target height levels in the environment. For instance, the shoulder pitch J1 joint may be rotated to a vertical up position to allow the robot to easily manipulate objects on a table in the environment. The shoulder pitch J1 joint may be rotated to a vertical down position to allow the robot to easily manipulate objects on a ground surface in the environment.

The bicep roll J2 joint allows the robot to rotate the bicep to move the elbow and forearm relative to the bicep. This motion may be particularly beneficial for facilitating a clear view of the EOAS by the robot's perception suite. By rotating the bicep roll J2 joint, the robot may kick out the elbow and forearm to improve line of sight to an object held in a gripper of the robot.

Moving down the kinematic chain, alternating pitch and roll joints (a shoulder pitch J1 joint, a bicep roll J2 joint, an elbow pitch J3 joint, a forearm roll J4 joint, a wrist pitch J5 joint, and wrist roll J6 joint) are provided to improve the manipulability of the robotic arm. The axes of the wrist pitch J5 joint, the wrist roll J6 joint, and the forearm roll J4 joint are intersecting for reduced arm motion to reorient objects. The wrist roll J6 point is provided instead of two pitch joints in the wrist in order to improve object rotation.

In some examples, a robotic arm such as the one illustrated in FIG. 4 may be capable of operating in a teach mode. In particular, teach mode may be an operating mode of the robotic arm that allows a user to physically interact with and guide robotic arm towards carrying out and recording various movements. In a teaching mode, an external force is applied (e.g., by the user) to the robotic arm based on a teaching input that is intended to teach the robot regarding how to carry out a specific task. The robotic arm may thus obtain data regarding how to carry out the specific task based on instructions and guidance from the user. Such data may relate to a plurality of configurations of mechanical components, joint position data, velocity data, acceleration data, torque data, force data, and power data, among other possibilities.

During teach mode the user may grasp onto the EOAS or wrist in some examples or onto any part of robotic arm in other examples, and provide an external force by physically moving robotic arm. In particular, the user may guide the robotic arm towards grasping onto an object and then moving the object from a first location to a second location. As the user guides the robotic arm during teach mode, the robot may obtain and record data related to the movement such that the robotic arm may be configured to independently carry out the task at a future time during independent operation (e.g., when the robotic arm operates independently outside of teach mode). In some examples, external forces may also be applied by other entities in the physical workspace such as by other objects, machines, or robotic systems, among other possibilities.

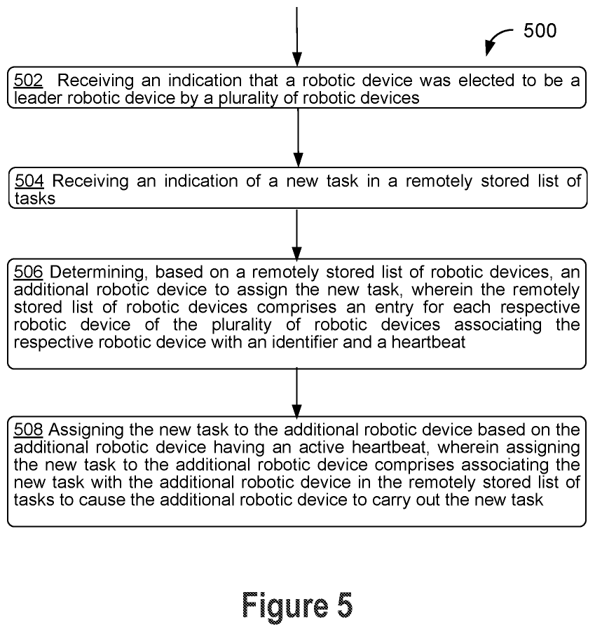

FIG. 5 is a block diagram of a method, in accordance with example embodiments. Blocks 502, 504, 506, and 508 may collectively be referred to as method 500. In some examples, method 500 of FIG. 5 may be carried out by a control system, such as control system 118 of robotic system 100. In further examples, method 500 of FIG. 5 may be carried out by a computing device or a server device remote from the robotic device. In still further examples, method 500 may be carried out by one or more processors, such as processor(s) 102, executing program instructions, such as program instructions 106, stored in a data storage, such as data storage 104. Execution of method 500 may involve a robotic device, such as the robotic device illustrated and described with respect to FIGS. 1-4. Further, execution of method 500 may involve a computing device or a server device remote from the robotic device and robotic system 100. Other robotic devices may also be used in the performance of method 500. In further examples, some or all of the blocks of method 500 may be performed by a control system remote from the robotic device. In yet further examples, different blocks of method 500 may be performed by different control systems, located on and/or remote from a robotic device.

Those skilled in the art will understand that the block diagram of FIG. 5 illustrates functionality and operation of certain implementations of the present disclosure. In this regard, each block of the block diagram may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art

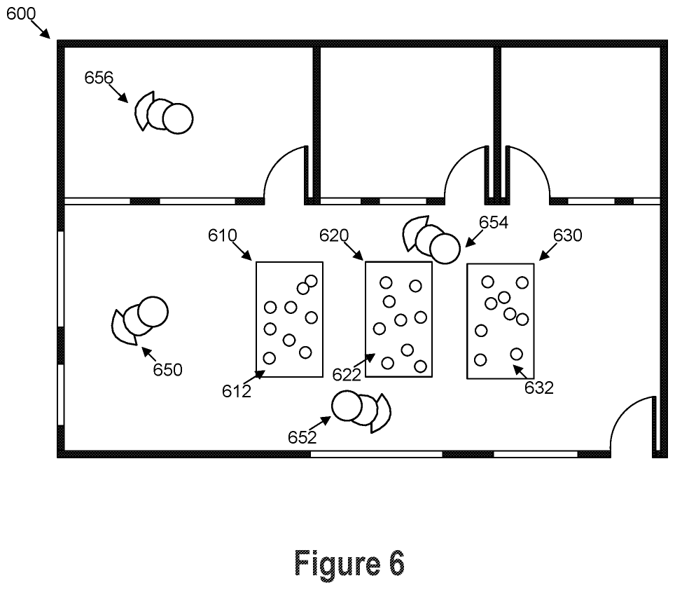

FIG. 6 depicts environment 600, in accordance with example embodiments. Environment 600 includes robotic devices 650, 652, 654, and 656. Robotic devices 650, 652, 654, and 656 may be part of a fleet of robotic devices operating in environment 600. Environment 600 may also include tables 610, 620, and 630, which may include objects 612, 622, and 632, respectively.

Robotic devices 650, 652, 654, and 656 may be assigned to various tasks in environment 600. For example, robotic device 652 may be tasked with clearing table 610 and robotic device 654 may be tasked with clearing table 620. Robotic device 656 may be in the environment but may be inactive, perhaps due to technical issues or other reasons.

Robotic devices 650, 652, 654, and 656 may be assigned and/or communicated these tasks through using a leader robotic device to assign tasks and monitor the heartbeat of robotic devices. Additionally and/or alternatively, a server device may carry out these operations in place of the leader robotic device. In both of these instances, robotic devices 650, 652, 654, and 656 may all communicate through a server device rather than communicating directly with each other (e.g., through robotic device to robotic device communication). As mentioned above, robotic devices communicating directly to a server rather than to another robotic device may help facilitate a scalable collaboration system.

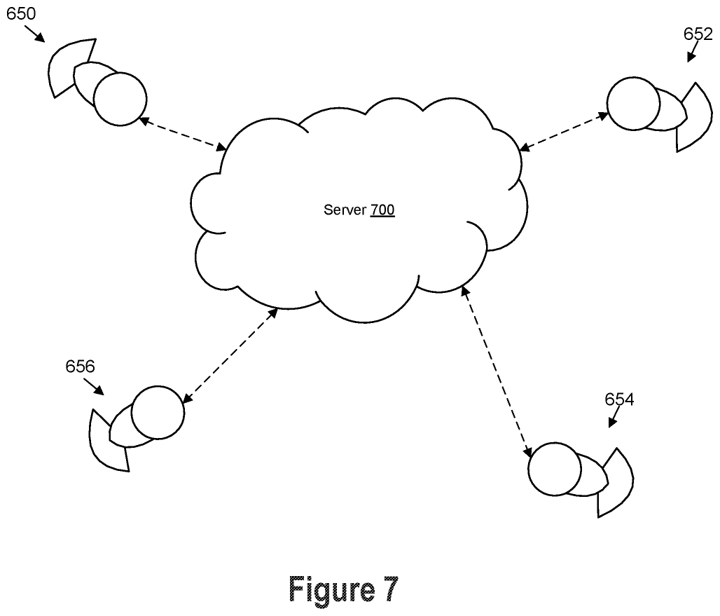

FIG. 7 depicts a communication workflow, in accordance with example embodiments. As depicted in FIG. 7, server 700 may transmit and receive signals from robotic devices 650, 652, 654, and 656. Each robotic device of robotic devices 650, 652, 654, and 656 may periodically send a signal to server 700 as an indication that the robotic device is still active. Server 700 may store a remotely stored list of tasks and a remotely stored list of robotic devices, which may include an entry for each of robotic devices 650, 652, 654, and 656. In some examples, the remotely stored list of tasks may be stored in a first state space and the remotely stored list of robotic devices may be stored in a second state space.

In some examples, a robotic device of a fleet of robotic devices may be designated as the leader robotic device, and the leader robotic device may help allocate tasks to the robotic devices of the fleet of robotic devices. For example, robotic devices 650, 652, 654, and 656 may be part of a fleet of robotic devices, and the robotic device 650 may be the leader robotic device. Server 700 may store an indication that robotic device 650 is a leader robotic device in a list of leader robotic devices.

In determining the leader robotic device, the robotic devices in the fleet of robotic devices may only communicate with server 700. For example, each robotic device of robotic devices 650, 652, 654, and 656 may detect, by communicating with server 700, that the entry associated with the leader robotic device is empty and/or that the leader robotic device is inactive. Additionally and/or alternatively, server 700 may send an indication to each of robotic devices 650, 652, 654, and 656 that the entry associated with the leader robotic device is empty and/or that the leader robotic device is inactive. Robotic devices may then proceed with electing a leader robotic device and sending a signal to the server accordingly.

Taking robotic device 650 as the leader robotic device as an example, leader robotic device 650 may monitor the remotely stored list of tasks stored in server 700 and determine to which robotic device in the list of robotic devices, if any, an unassigned task in the remotely stored list of tasks may be assigned. In particular, leader robotic device 650 may receive an indication from server 700 whenever a new task is added to the remotely stored list of tasks. In response to receiving an indication from server 700, leader robotic device 650 may determine a robotic device in the list of robotic devices to assign the task, for example, robotic device 652. Leader robotic device 650 may select the robotic device from the list of robotic devices based on the selected robotic device having the ability to carry out the task and/or based on the selected robotic device having the greatest probability of having the ability to carry out the task. For example, robotic device 652 may have the ability to pick up and carry small objects, whereas robotic device 654 may have the ability to wipe surfaces, and robotic device 656 may have the ability to pick up and carry large objects. Given a task of clearing objects from a table, leader robotic device 650 may select robotic device 652 as a robotic device that is carrying out such a task likely needs the ability to pick up small objects (e.g., plates, bowls, glasses, etc.).

Additionally and/or alternatively, the fleet of robotic devices may not elect a leader robotic device. Instead, each robotic device of the fleet of robotic devices may monitor the list of tasks stored in server 700. When a robotic device detects a new task in the list of tasks and the robotic device determines that it has the ability to carry out the task, the robotic device may send an indication to server 700 to add itself as the robotic device carrying out the task.

Other examples of communication workflows are also possible. Further, the communication workflow may involve additional robotic devices or a subset of robotic devices 650, 652, 654, and 656. Further, the communication workflow may include a single server (e.g., server 700) or any number of additional servers. In some examples, server 700 may be a cloud hosted database, such as FIREBASE® or FIRESTORE®.

In further examples, the communication workflow may be similar to a chat room, where server 700 is used for communicating messages among robotic devices and/or operators, perhaps through a natural language mode. The natural language mode may involve the task being described using a natural language prompt (e.g., “clear the table”), rather than a numerical or symbolic representation of the task. When the task is assigned to a robotic device, server 700 may update the task to also state the robotic device (e.g., the updated task may state “clear the table robotic device 652”). With tasks being represented in this manner, an operator may easily input tasks and monitor the status of tasks.

Referring back to FIG. 5, at block 502, method 500 includes receiving an indication that a robotic device was elected to be a leader robotic device by a plurality of robotic devices. The plurality of robotic devices may include robotic devices of a fleet of robotic devices. As mentioned above, each robotic device in the fleet of robotic devices may be listed in a remotely stored list of robotic devices, and the fleet of robotic devices may determine the leader robotic device.

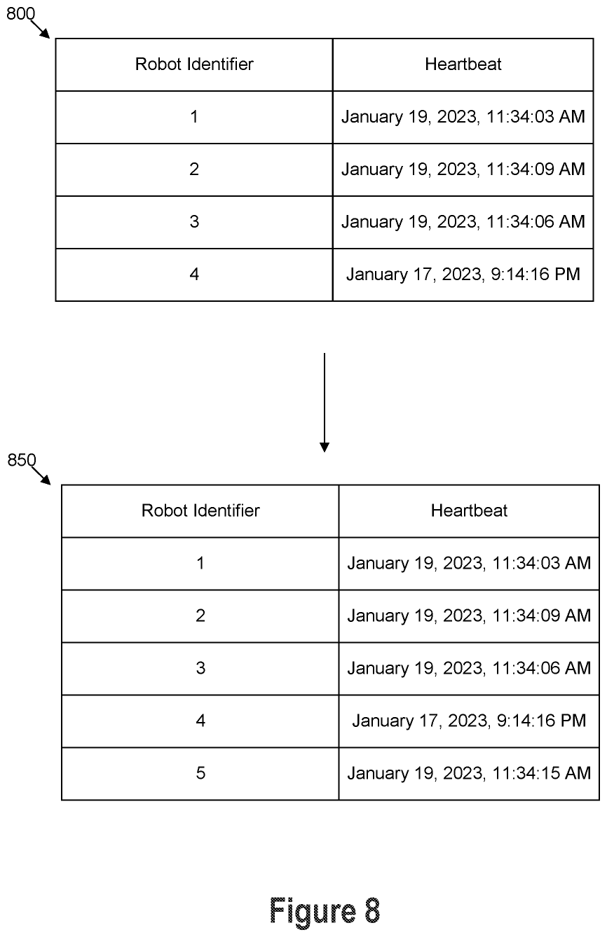

FIG. 8 depicts remotely stored list of robotic devices 800 and updated remotely stored list of robotic devices 850, in accordance with example embodiments. Remotely stored list of robotic devices 800 and updated remotely stored list of robotic devices 850 may include robot identifiers and heartbeats for each robotic device. In particular, the fleet of robotic devices identified by remotely stored list of robotic devices 800 may include a robotic device with an identifier of “1.” The robotic device with an identifier of “1” may have last checked in with the server on Jan. 19, 2023, 11:34:03 AM, which is indicated by the “Heartbeat” value. Similarly, the fleet of robotic devices may include a robotic device with an identifier of “2,” and this robotic device may have last checked in with the server on Jan. 19, 2023, 11:34:09 AM. The fleet of robotic devices may also include a robotic device with an identifier of “3,” and this robotic device may have an associated heartbeat value of Jan. 19, 2023, 11:34:06 AM. And the fleet may further include a robotic device with an identifier of “4” and this robotic device may have an associated heartbeat value of Jan. 17, 2023, 9:14:16 PM. In practice, the heartbeat values may be timestamps that are comparable (e.g., having the same timezone), which may be specified by the robotic devices or may be assigned by the server based on the time when a given robotic device sends a state update to the server. For example, the heartbeat values of a remotely stored list of robotic devices may be indicated in milliseconds since epoch in Coordinated Universal Time (UTC).

The heartbeat values may be used by a leader robotic device or a server to determine whether the robotic device is active, perhaps if the heartbeat indicates a last check in time of less than at least threshold amount of time from a current time. For example, a leader robotic device monitoring remotely stored list of robotic devices 800 may determine that the robotic device associated with robot identifier “4” is inactive. The leader robotic device may then assign the task of the robotic device associated with robot identifier “4” to another robotic device that is associated with being active or monitor the list of robotic devices for a new robotic device that may be active.

In some instances, a new robotic device may join the fleet of robotic devices. To join the fleet of robotic devices, the new robotic device may send a signal to the server to be added to remotely stored list of robotic devices 800. The server may then update the remotely stored list of robotic devices 800 to add a new entry for the new robotic device, as shown in updated remotely stored list of robotic devices 850. The entry for the new robotic device may likewise include a robot identifier as well as a heartbeat.

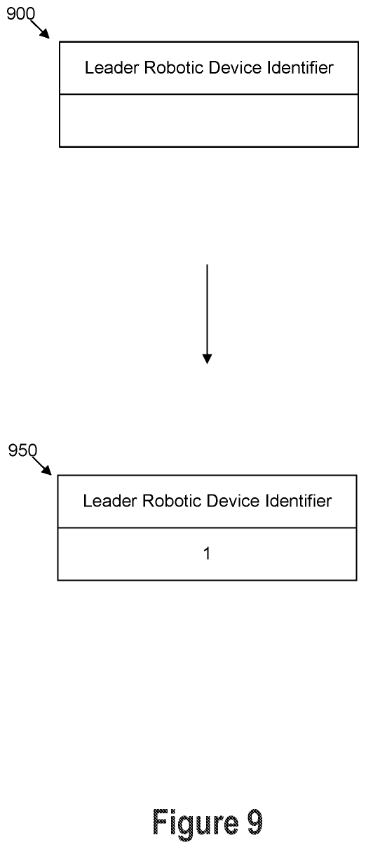

Next, an indication of the leader robotic device may be stored in a separate list. FIG. 9 depicts remotely stored list of leader robotic devices 900 and updated remotely stored list of leader robotic devices 950, in accordance with example embodiments. Each robotic device stored in updated remotely stored list of robotic devices 850 may monitor remotely stored list of leader robotic devices 900 and updated remotely stored list of robotic devices 850 to determine whether list of leader robotic devices 900 contains an identifier for the leader robotic device of the fleet and if so, whether the leader robotic device of the fleet is still active.

If list of leader robotic devices 900 does not contain an identifier for the leader robotic device of the fleet and/or if the leader robotic device of the fleet is not active, robotic devices in updated remotely stored list of robotic devices 850 may elect a robotic device as the leader robotic device through the use of one or more leadership election algorithms. Alternatively, each of the robotic devices in the updated remotely stored list of robotic devices 850 may elect themselves by attempting to add themselves to the list of leader robotic devices 900, and the robotic device that is successful in adding themselves to the list of leader robotic devices 900 may be considered the leader of the fleet of robotic devices. Still alternatively, a server or a robotic device in the fleet of robotic devices may randomly determine a leader robotic device, and this randomly selected robotic device may be deemed the leader of the fleet of robotic devices. Updated list of leader robotic devices 950 includes the identifier for the elected leader robotic device, the robotic device with the identifier “1.”

Referring back to FIG. 5, at block 504, method 500 includes receiving an indication of a new task in a remotely stored list of tasks. In some examples, the leader robotic device may receive an indication that a new task has been added to the remotely stored list of tasks, perhaps by a robotic device carrying out another task or by an operator.

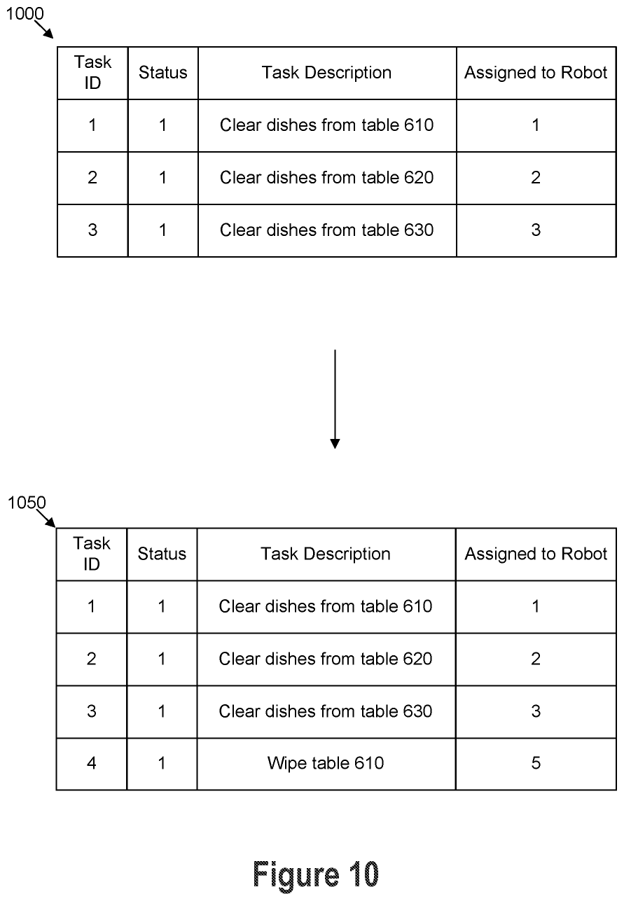

FIG. 10 depicts remotely stored list of tasks 1000 and updated remotely stored list of tasks 1050, in accordance with example embodiments. Each entry in remotely stored list of tasks 1000 and/or updated remotely stored list of tasks 1050 may include a task ID, a status, a task description, and the ID of the robotic device to which it is assigned. Additionally and/or alternatively, each entry in the remotely stored list of task 1000 and updated remotely stored list of tasks 1050 may be associated with a heartbeat, measured in milliseconds since epoch, that indicates the last time a robotic device attempted carrying out the task.

Tasks in remotely stored list of tasks 1000 could include various tasks to be carried out in environment 600, such as “clear dishes from table 610,” “clear dishes from table 620,” and “clear dishes from table 630.” Each task in remotely stored list of tasks 1000 could be assigned to a robotic device operating in environment 600.

In carrying out its assigned task, the robotic device may determine an additional task that may need to be carried out. For example, the robotic device assigned to task “1” to “clear dishes from table 610” may determine that the table also needs to be wiped. The robotic device may then send an indication to the server to add a task to “wipe table 610” to remotely stored list of tasks 1000, and the server may update remotely stored list of tasks 1000 to include “wipe table 610,” as shown in updated remotely stored list of tasks 1050.

Referring back to FIG. 5, at block 506, method 500 includes determining, based on a remotely stored list of robotic devices, an additional robotic device to assign the new task, where the remotely stored list of robotic devices comprises an entry for each respective robotic device of the plurality of robotic devices associating the respective robotic device with an identifier and a heartbeat.

In particular, upon updating the remotely stored list of tasks, the server may then notify the leader robotic device that an additional task has been added to the remotely stored list of tasks. Upon receiving such a notification, the leader robotic device may query the list of robotic devices to determine which robotic device may be capable of carrying out the task. In this instance, the leader robotic device may determine to assign it to the robotic device associated with an identifier of “5.” To determine to which robotic device to assign the task, the leader robotic device may filter robotic devices in the list of robotic devices by various factors and robotic device specifications, including, whether the robotic device is in the process of carrying out a task, whether the robotic device is active, and whether the robotic device has the components needed to carry out the task, among others. After selecting a robotic device to which to assign the task, the robotic device may send an indication to the server to update the remotely stored list of tasks to assign the task to the selected robotic device. For example, in updated remotely stored list of tasks 1050, the leader robotic device may send an indication to update a task with the ID “4” to be assigned to robotic device “5” in the remotely stored list of robotic devices.

Additionally and/or alternatively, the server may notify each robotic device in the list of robotic devices that a new task was added to the remotely stored list of robotic devices. In response, each robotic device may evaluate whether it can carry out the task based on the task that the robotic device is carrying out at that time, if any, whether the robotic device has the components needed to carry out the task, and/or whether the robotic device is active, among other factors. If the robotic device determines that it is capable of carrying out the task, the robotic device may send an indication to the server and the server may update the remotely stored list of tasks to assign the new task to the first robotic device from which the server receives an indication of being able to carry out the task.

Referring back to FIG. 5, at block 508, method 500 includes assigning the new task to the additional robotic device based on the additional robotic device having an active heartbeat, where assigning the new task to the additional robotic device comprises associating the new task with the additional robotic device in the remotely stored list of tasks to cause the additional robotic device to carry out the new task. For example, associating a robotic device with an ID of “5” to the task with task ID “4” may cause the robotic device with the ID of “5” to carry out wiping table 610.

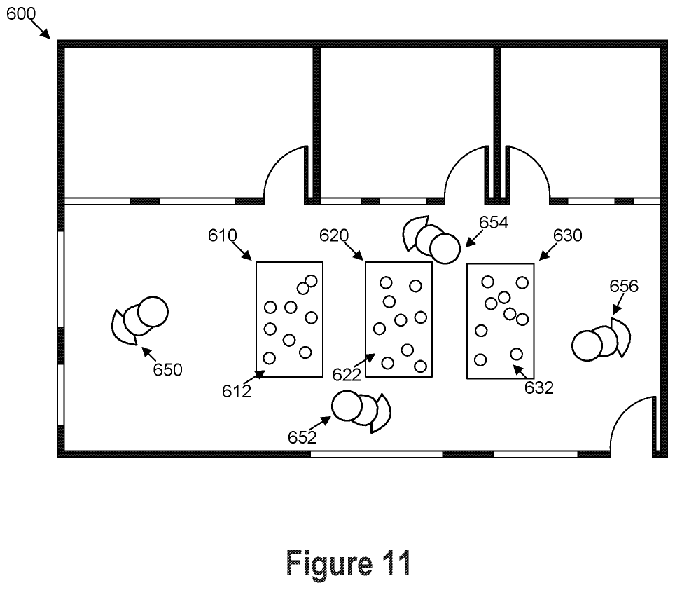

FIG. 11 depicts updated environment 1100, in accordance with example embodiments. Updated environment 1100 may include robotic devices 650, 652, 654, and 658. Robotic device 658 may have a robot ID of “5.” When the server updates the task with task ID “4,” to be associated with a robotic device of robot ID “5,” the server may send a signal to the robotic device 658, which may cause the robotic device 658 to attempt to carry out the task of wiping table 610.

In some examples, the remotely stored list of tasks comprises an entry for each task associating each task with a status indicator.

In some examples, method 500 further includes receiving an indication of a new robotic device in the remotely stored list of robotic devices, determining a task from the remotely stored list of tasks to assign to the new robotic device, and assigning the task to the new robotic device based on the new task having an active status indicator, where assigning the task to the new robotic device comprises associating the task with the new robotic device in the remotely stored list of tasks to cause the new robotic device to carry out the task.

In some examples, receiving the indication that the robotic device was elected to be the leader robotic device is based on the robotic device having an active heartbeat.

In some examples, method 500 further includes transmitting, by the leader robotic device to a server device that stores the remotely stored list of robotic devices, an indication of the leader robotic device still having an active heartbeat.

In some examples, transmitting the indication of still having the active heartbeat is periodic.

In some examples, the remotely stored list of robotic devices is stored in a first state space and the remotely stored list of tasks is stored in a second state space.

In some examples, the remotely stored list of robotic devices is stored on a server, where the additional robotic device having the active heartbeat indicates that the additional robotic device transmitted an indication to the server of being active less than at least a threshold amount of time from a current time.

In some examples, the remotely stored list of robotic devices is stored on a server, where the additional robotic device transmits an indication to the server of having an active heartbeat periodically.

In some examples, the remotely stored list of tasks and the remotely stored list of robotic devices are both stored in a database.

In some examples, receiving the indication that the robotic device was elected to be the leader robotic device comprises monitoring a current leader field for the list of robotic devices, transmitting, by the leader robotic device, an indication to add the robotic device to the current leader field, and receiving an indication that transmitting the indication to add the robotic device was successful.

In some examples, the current leader field is part of a remotely stored list of leader robotic devices.

In some examples, receiving the indication that the robotic device was elected to be the leader robotic device by the plurality of robotic devices is based on carrying out a leadership election algorithm.

In some examples, determining, by the leader robotic device and based on the remotely stored list of robotic devices, the additional robotic device to assign the new task comprises determining a subset of robotic devices from the remotely stored list of robotic devices, where each robotic device in the subset has an active heartbeat and is not already associated with a task.

In some examples, determining the additional robotic device to assign the new task is based on one or more requirements of the new task and one or more specifications of the additional robotic device.

In some examples, method 500 further comprises receiving, by the leader robotic device, an indication of a further new task in the remotely stored list of tasks, where the further new task was added by the additional robotic device in carrying out the assigned new task, and assigning the further new task to a further robotic device in the remotely stored list of robotic devices.

In some examples, each robotic device in the list of robotic devices is operating in a same region.

In some examples, a system for distributing and synchronizing tasks among a plurality of robotic devices is provided. The system comprises a database server having stored thereon a list of tasks and a list of robotic devices, where the list of robotic devices comprises an entry for each respective robotic device of the plurality of robotic devices, where each entry associates the respective robotic device with an identifier and a heartbeat. The system also includes the plurality of robotic devices. A given robotic device of the plurality of robotic devices comprises a control system configured to receive, by the given robotic device from the database server, a first wireless communication signal indicating that the given robotic device was elected to be a leader robotic device by the plurality of robotic devices, where the system is configured to replace the leader robotic device if the leader robotic device has an inactive heartbeat. The control system is also configured to receive, by the leader robotic device from the database server, a second wireless communication signal indicating a new task in the list of tasks stored at the database server. The control system is further configured to determine, by the leader robotic device and based on the list of robotic devices stored at the database server, an additional robotic device to assign the new task. The control system is additionally configured to assign, by the leader robotic device, the new task to the additional robotic device based on the additional robotic device having an active heartbeat, where the additional robotic device is configured to perform the new task responsive to receiving, from the database server, a third wireless communication signal indicating that the new task is assigned to the additional robotic device in the list of tasks stored at the database server.

In some examples, the list of tasks comprises an entry for each task associating each task with a status indicator.

In some examples, the control system of the given robotic device is further configured to receive an indication of a new robotic device in the list of robotic devices. The control system is also configured to determine a task from the list of tasks stored at the database server to assign to the new robotic device. The control system is further configured to assign the task to the new robotic device based on the new task having an active status indicator, where assigning the task to the new robotic device comprises associating the task with the new robotic device in the list of tasks stored at the database server to cause the new robotic device to carry out the task.

In some examples, the election of the given robotic device to be the leader robotic device is based on the given robotic device having an active heartbeat.

In some examples, the control system of the given robotic device is further configured to monitor a current leader field for the list of robotic devices, transmit, by the leader robotic device, an indication to add the given robotic device to the current leader field, and receive an indication that transmitting the indication to add the given robotic device was successful.

In some examples, the current leader field is part of a list of leader robotic devices stored at the database server.

In some examples, the election of the given robotic device to be the leader robotic device by the plurality of robotic devices is based on carrying out a leadership election algorithm.

In some examples, each robotic device of the plurality of robotic devices is operating in a same region.

### III. CONCLUSION

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The above detailed description describes various features and functions of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

A block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical functions or actions in the method or technique. The program code or related data may be stored on any type of computer readable medium such as a storage device including a disk or hard drive or other storage medium.

The computer readable medium may also include non-transitory computer readable media such as computer-readable media that stores data for short periods of time like register memory, processor cache, and random access memory (RAM). The computer readable media may also include non-transitory computer readable media that stores program code or data for longer periods of time, such as secondary or persistent long term storage, like read only memory (ROM), optical or magnetic disks, compact-disc read only memory (CD-ROM), for example. The computer readable media may also be any other volatile or non-volatile storage systems. A computer readable medium may be considered a computer readable storage medium, for example, or a tangible storage device.

Moreover, a block that represents one or more information transmissions may correspond to information transmissions between software or hardware modules in the same physical device. However, other information transmissions may be between software modules or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A system for distributing and synchronizing tasks among a plurality of robotic devices, the system comprising:
a database server having stored thereon a list of tasks and a list of robotic devices, wherein the list of robotic devices comprises an entry for each respective robotic device of the plurality of robotic devices, wherein each entry associates the respective robotic device with an identifier and a heartbeat; and
the plurality of robotic devices, wherein a given robotic device of the plurality of robotic devices comprises a control system configured to:
receive, by the given robotic device from the database server, a first wireless communication signal indicating that the given robotic device was elected to be a leader robotic device by the plurality of robotic devices, wherein the system is configured to replace the leader robotic device if the leader robotic device has an inactive heartbeat;
receive, by the leader robotic device from the database server, a second wireless communication signal indicating a new task in the list of tasks stored at the database server;
determine, by the leader robotic device and based on the list of robotic devices stored at the database server, an additional robotic device to assign the new task; and
assign, by the leader robotic device, the new task to the additional robotic device based on the additional robotic device having an active heartbeat, wherein the additional robotic device is configured to perform the new task responsive to receiving, from the database server, a third wireless communication signal indicating that the new task is assigned to the additional robotic device in the list of tasks stored at the database server.

2. The system of claim 1, wherein the list of tasks comprises an entry for each task associating each task with a status indicator.

3. The system of claim 2, wherein the control system of the given robotic device is further configured to:
receive an indication of a new robotic device in the list of robotic devices;
determine a task from the list of tasks stored at the database server to assign to the new robotic device; and
assign the task to the new robotic device based on the new task having an active status indicator, wherein assigning the task to the new robotic device comprises associating the task with the new robotic device in the list of tasks stored at the database server to cause the new robotic device to carry out the task.

4. The system of claim 1, wherein the election of the given robotic device to be the leader robotic device is based on the given robotic device having an active heartbeat.

5. The system of claim 1, wherein the control system of the given robotic device is further configured to:
monitor a current leader field for the list of robotic devices;
transmit an indication to add the given robotic device to the current leader field; and
receive an indication that transmitting the indication to add the given robotic device was successful.

6. The system of claim 5, wherein the current leader field is part of a list of leader robotic devices stored at the database server.

7. The system of claim 1, wherein the election of the given robotic device to be the leader robotic device by the plurality of robotic devices is based on carrying out a leadership election algorithm.

8. The system of claim 1, wherein each robotic device of the plurality of robotic devices is operating in a same region.

9. A method comprising:
receiving, by a robotic device, an indication that the robotic device was elected to be a leader robotic device by a plurality of robotic devices;
receiving, by the leader robotic device, an indication of a new task in a remotely stored list of tasks;
determining, by the leader robotic device and based on a remotely stored list of robotic devices, an additional robotic device to assign the new task, wherein the remotely stored list of robotic devices comprises an entry for each respective robotic device of the plurality of robotic devices associating the respective robotic device with an identifier and a heartbeat; and
assigning, by the leader robotic device, the new task to the additional robotic device based on the additional robotic device having an active heartbeat, wherein assigning the new task to the additional robotic device comprises associating the new task with the additional robotic device in the remotely stored list of tasks to cause the additional robotic device to carry out the new task.

10. The method of claim 9, further comprising:
transmitting, by the leader robotic device to a server device that stores the remotely stored list of robotic devices, an indication of the leader robotic device still having an active heartbeat.

11. The method of claim 9, wherein transmitting the indication of still having the active heartbeat is periodic.

12. The method of claim 9, wherein the remotely stored list of robotic devices is stored in a first state space and the remotely stored list of tasks is stored in a second state space.

13. The method of claim 9, wherein the remotely stored list of robotic devices is stored on a server, wherein the additional robotic device having the active heartbeat indicates that the additional robotic device transmitted an indication to the server of being active less than at least a threshold amount of time from a current time.

14. The method of claim 9, wherein the remotely stored list of robotic devices is stored on a server, wherein the additional robotic device transmits an indication to the server of having an active heartbeat periodically.

15. The method of claim 9, wherein the remotely stored list of tasks and the remotely stored list of robotic devices are both stored in a database.

16. The method of claim 9, wherein determining, by the leader robotic device and based on the remotely stored list of robotic devices, the additional robotic device to assign the new task comprises:
determining a subset of robotic devices from the remotely stored list of robotic devices, wherein each robotic device in the subset has an active heartbeat and is not already associated with a task.

17. The method of claim 9, wherein determining the additional robotic device to assign the new task is based on one or more requirements of the new task and one or more specifications of the additional robotic device.

18. The method of claim 9, further comprising:
receiving, by the leader robotic device, an indication of a further new task in the remotely stored list of tasks, wherein the further new task was added by the additional robotic device in carrying out the assigned new task; and
assigning the further new task to a further robotic device in the remotely stored list of robotic devices.

19. The method of claim 9, further comprising:
receiving, by the leader robotic device, an indication of a further new task;
determining, based on the remotely stored list of robotic devices, that no further robotic devices are available to assign the further new task; and
waiting, by the leader robotic device, for an indication of a further robotic device.

20. A non-transitory computer readable medium comprising program instructions executable by at least one processor to cause the at least one processor to perform functions comprising:
receiving, by a robotic device, an indication that the robotic device was elected to be a leader robotic device by a plurality of robotic devices;
receiving, by the leader robotic device, an indication of a new task in a remotely stored list of tasks;
determining, by the leader robotic device and based on a remotely stored list of robotic devices, an additional robotic device to assign the new task, wherein the remotely stored list of robotic devices comprises an entry for each respective robotic device of the plurality of robotic devices associating the respective robotic device with an identifier and a heartbeat; and
assigning, by the leader robotic device, the new task to the additional robotic device based on the additional robotic device having an active heartbeat, wherein assigning the new task to the additional robotic device comprises associating the new task with the additional robotic device in the remotely stored list of tasks to cause the additional robotic device to carry out the new task.
